(19) United States
(12) Patent Application Publication
(10) Pub. No.: US 2012/0203698 A1
(43) Pub. Date: Aug. 9, 2012

(54) Method and System for Fraud Detection and Notification

(76) Inventors: Dustin Duncan, Highlands Ranch, CO (US); Gloria Mai, Littleton, CO (US)

(21) Appl. No.: 13/368,101

(22) Filed: Feb. 7, 2012

Related U.S. Application Data
(60) Provisional application No. 61/440,259, filed on Feb. 7, 2011.

(51) Int. Cl. G06Q 20/40

(52) U.S. Cl. 705/44

(57) ABSTRACT

Methods and systems for an automated dialer enhancements. The methods may analyze transactions. The analysis of the transactions may comprise of triggers which are met when a delta threshold is exceeded, when an immediate threshold is exceeded, or when a rule is met. A notification strategy is implemented after a trigger is fired and accounts may be blocked or held. Reappearing transactions are flagged and escalated.

### CROSS REFERENCES TO RELATED APPLICATIONS

This application claims priority from U.S. Provisional Patent Application No. 61/440,259, filed on Feb. 7, 2011, the contents of which are hereby incorporated in their entirety by reference.

### BACKGROUND

Identity theft has become an increasingly common problem occurring in today's largely electronic transaction and payment processing infrastructure. With the increase of non-cash based financial transactions being conducted, such as credit card or debit card transactions, the number of fraudulent transactions has increased as well. A consumer's payment device (e.g., credit card, debit card, ATM card, etc.) associated with the consumer's accounts, can be stolen, or an associated identifier for the payment device comprised, allowing a fraudster to have unlimited access to the consumer's associated accounts, until fraud has been detected and the accounts or payment devices canceled. Transactions conducted with a physical payment device may be categorized as card-present transactions. Transaction conducted with payment device identifiers or other associated identifiers, may be distinguished as card-not-present transactions.

Manual detection of fraud in card-present transactions can be slow and difficult, for example, in the time it takes for the consumer to realize that his or her payment device is missing, such as in the case of a stolen or lost payment device, the fraudster may have already accessed the accounts fraudulently or conducted several fraudulent transactions. Additionally, some merchants may or may not check identification at the time of purchase with the stolen payment device, and some transactions using the stolen payment device may be conducted at a point-of-sale device or other device, such as an Automated Teller Machine (ATM), without identification verification (e.g., self-checkout, cash withdrawal).

In both card-present transactions and card-not-present transactions, the transaction is still processed electronically through a series of electronic transmissions between entities, for example a transaction processing system, payment processing network, acquirer, and/or issuer, there are many opportunities for fraudsters to intercept electronic transmissions and extrapolate account identifiers or other valuable financial data. Thus, when the payment device is still in possession of the consumer, there is still a risk of electronic interception. Internet, and other card-not-present transactions (e.g., mobile phone transactions, telephone transactions), are even more vulnerable to electronic interception of valuable personal financial data. Fraudulent activity in card-not-present transactions are even more difficult to manually detect since the consumer is still in possession of the payment device. The consumer may not discover that his or her payment device has been comprised and fraudulent transactions have been conducted on the associated account until receipt of a monthly account billing statement listing all transactions. By then, it may be too late and too difficult, if not impossible, to contest the fraudulent transactions and be reimbursed for such losses.

Although currently in existing payment and transaction processing infrastructures there are electronic security protocols in place to encrypt transmissions to prevent fraudulent interception of personal financial data, there still is always a risk. Since much of the processing occurs electronically through transmissions through entities, storing data on computers and databases, there is ample opportunity for fraudsters to access the stored data on computers or electronic transmissions of the data. New security protocols implemented in existing payment and transaction processing infrastructures meant to protect consumers can still be learned and circumvented by experienced and highly technical fraudsters, thus the problem of identity theft and fraudulent transactions must be approached both defensively and offensively. Detecting a potentially fraudulent transaction and identifying fraudulent activity the moment it occurs is just as important as preventing it. As technology has made conducting transactions more convenient and instantaneous for legitimate consumers, fraudulent activity has also become extremely convenient and instantaneous for fraudsters. Therefore intelligent, technical, and automated systems and methods of instant detection and identification of potentially fraudulent and fraudulent activity are critically needed. Additionally, the consumer needs to be instantly notified when fraudulent activity has been determined so he or she can take further action.

Existing fraud detection methods are typically performed by automated dialers, and may be in connection with a payment or transaction processing system. The current methods used by automated dialers use relatively simple checks, and can be easily circumvented by fraudsters. Thus, actual fraudulent transactions conducted by fraudsters may pass through existing fraud detection checks and be identified as legitimate transactions conducted by consumers. Again, the consumer may not discover fraudulent activity has occurred, and may not be able to cancel his or her account, until it is too late. Alternatively, legitimate (non-fraudulent) transactions conducted by the consumer may be inappropriately flagged as fraudulent activity as occasionally the consumer may make a transaction that inadvertently does not pass through an existing fraud detection check. In existing fraud detection methods and systems, when this occurs, an issuer of the payment device may automatically decline the transaction or block the account from further transactions, without notifying the consumer. This can be extremely frustrating and confusing for the consumer, who may be unable to conduct a legitimate transaction without calling the issuer to re-activate the account, clarify with the issuer why the transaction was declined, or confirm the transaction is legitimate. In other existing fraud detection methods performed by an automated dialer, issuer, or other entity, there may be steps to automatically notify the consumer when a potentially fraudulent transaction has occurred. However, if a legitimate transaction has been erroneously flagged as fraudulent, the consumer may receive unwanted and repeated notifications from the automated dialer, issuer, or other entity.

Thus, technical systems and methods to identify potential fraud, intelligently and accurately detect actual fraud, as well as efficient and effective methods to notify consumers of the actual fraud, are needed. Embodiments of the technology disclosed herein address these and other problems, individually and collectively.

### BRIEF SUMMARY

Embodiments of the invention relate to improved systems and methods for automated dialer enhancements used in fraud detection and notification.

One embodiment is directed to a method, the method comprising a) receiving a transaction case comprising transaction data associated with an account, wherein the transaction data includes a first transaction score, b) determining, by the server computer, a transaction score delta using the first transaction score and a second transaction score, c) determining if the transaction score delta meets a delta trigger, d) determining an immediate transaction score, e) determining if the immediate transaction score meets an immediate trigger, f) determining if the transaction data in the transaction case meets one or more rule triggers, and g) performing additional processing if steps c), e), and f) are met.

In other embodiments of the invention, the method further comprising performing additional processing. Additional processing may include, performing a notification strategy or placing a block on the account.

In other embodiments of the invention, the method further comprising storing transaction data associated with the transaction case in a database, analyzing stored transaction data to determine a pattern, determining strategy rule triggers using strategy rules based on the pattern, and determining if the transaction data in the transaction case meets one or more strategy rule triggers.

Another embodiment of the invention is directed towards a server computer comprising a processor and a non-transitory computer readable medium. The non-transitory computer readable medium comprises code, executable by the processor, to perform a method, the method comprising a) receiving a transaction case comprising transaction data associated with an account, wherein the transaction data includes a first transaction score, b) determining, by the server computer, a transaction score delta using the first transaction score and a second transaction score, c) determining if the transaction score delta meets a delta trigger, d) determining an immediate transaction score, e) determining if the immediate transaction score meets an immediate trigger, f) determining if the transaction data in the transaction case meets one or more rule triggers, and g) performing additional processing if steps c), e), and f) are met.

In other embodiments, the server computer may also perform additional processing. Additional processing may include, performing a notification strategy or placing a block on the account.

In other embodiments, the server computer may comprise a database to store transaction data associated with the transaction case in the database. The method may further comprise analyzing stored transaction data to determine a pattern, determining strategy rule triggers using strategy rules based on the pattern, and determining if the transaction data in the transaction case meets one or more strategy rule triggers.

Embodiments of the invention can also include a fraud detection process which includes the combined evaluation of (a) a delta trigger (e.g., the fraud score has jumped significantly in a short period of time), (b) an immediate trigger (e.g., a single transaction exceeds a score threshold), and (c) a rules fired trigger (e.g., a transaction satisfies a particular rule such as no merchants from Nigeria). Once this combination of rules is satisfied, a notification strategy (e.g., e-mail, phone, etc.) may commence, and the account may be automatically blocked if the notification strategy and trigger/scoring thresholds are satisfied.

These and other embodiments of the invention are described in further detail below.

### BRIEF DESCRIPTION OF THE DRAWINGS

FIG. 1 is a system diagram showing an exemplary system according to an example embodiment.

FIG. 2 is a system flow diagram showing an exemplary case creation flow according to an example embodiment.

FIG. 3 is a flow diagram illustrating an overview flow according to an example embodiment.

FIG. 4 is a flow diagram illustrating a case processing flow according to an example embodiment.

FIG. 5 is a flow diagram illustrating rule based trigger logic, according to an example embodiment.

FIG. 6 is a flow diagram illustrating score based trigger logic, according to an example embodiment.

FIG. 7 is a flow diagram illustrating a notification flow, according to an example embodiment.

FIG. 8 is a flow diagram illustrating a notification flow, according to another example embodiment.

FIG. 9 is a block diagram showing a transaction processing system server computer according to an example embodiment.

FIG. 10 is a block diagram showing an exemplary computer system according to an example embodiment.

### DETAILED DESCRIPTION

Financial transactions made be conducted in many ways, including as card-present transactions (e.g., using a credit card to make a purchase at a retail store) or as card-not-present transactions (e.g., using a credit card identifier to make a purchase over the Internet). Financial transactions are typically processed by payment processing systems or transaction processing systems. Payment and transaction processing systems traditionally involve a process whereby a merchant/acquirer access device (e.g., point of sale (POS) device) for card-present transactions, or another payment channel for card-not-present transactions, such as the internet, is used integrally as part of a transaction initiation process. For example, in a card-present transaction, a consumer making a purchase at a merchant's store may present a payment card (e.g., credit card) to the merchant, who then swipes the card using a card reader that is integrated with the merchant's access device.

Transaction data is read from the payment card, including data that characterizes the transaction, such as the purchase amount, is then sent to the merchant's acquirer. Traditionally, the sending of transaction data may be sent using a device operated by the merchant (e.g., a POS device or a merchant server). Often the merchant sends transaction data to an acquirer, typically a financial institution that maintains a banking relationship with the merchant. The acquirer may then send the transaction data to an issuer of the consumer's payment card in an authorization request message. The transaction data may be sent via a card association network, such as VisaNet™. Upon receipt by the issuer, a determination is made regarding whether the transaction should be approved or declined. For example, the issuer may determine if the consumer has sufficient funds or credit to cover the purchase amount. The issuer then sends an authorization response message, via the card association network and/or the acquirer, back to the merchant that indicates if the transaction is approved or declined.

In card-present transaction, the consumer is vulnerable to fraud because the payment card must be presented to the merchant for processing and may become compromised. For example, the merchant may improperly handle the payment card or improperly store an associated account identifier, potentially leading to fraud. There is also the risk of a data security breach of the merchant's POS terminal or hardware systems, causing the consumer's financial data to become public or accessible to other. In another example, dishonest employees of the merchant may utilize the account identifier to make unauthorized purchases. In yet another example, the consumer's account identifier could be intercepted while being read by the merchant. For example, sophisticated fraudsters have been known to attach devices to a merchant's POS terminal in order to steal credit card numbers. Thus, consumers may be reluctant to engage in a transaction with an untrusted or unfamiliar merchant because they must provide sensitive payment account data to the merchant.

In a card-present transaction, since the consumer is in physical possession of the payment card, the merchant can physically examine the payment card, verify identification, and be assured that the consumer is in physical possession of the payment card and is conducting a legitimate (non-fraudulent) transaction. However, with the increased reliance on the Internet and other communication channels, consumers can conduct remote transactions, which can otherwise be referred to as card-not-present transactions. A typical card-not-present transaction may comprise, for example, a consumer making a purchase on a merchant's website. The merchant does not have physical access to the consumer's payment card, and as such, the card is not present at the point of the transaction. Unlike card-present transactions, where the consumer may physically hand the payment card to the merchant for swiping and inspection, a card-not-present transaction typically involves the consumer entering in an account identifier associated with the payment card into the merchant website, or in other examples, such as a phone transaction, keying in or speaking the account identifier.

In both card-present and card-not-present transactions, the processing of the transaction involves electronic transmission of data, including account identifiers or other personal financial data, between various entities, for example, a merchant, a transaction or payment processing system, an issuer, and/or an acquirer. While current technology provides some security in communication channels, such as encrypting data transmissions over the Internet, there is still opportunity for sophisticated fraudsters to intercept electronic transmissions of transaction data, decrypt valuable information, and conduct fraudulent transactions with the stolen account identifiers.

Existing fraud detection methods are typically performed by automated dialers, and may be in connection with a payment or transaction processing system. The current methods used by automated dialers use relatively simple checks, and can be easily circumvented by fraudsters. Thus, actual fraudulent transactions conducted by fraudsters may pass through existing fraud detection checks and be identified as legitimate transactions conducted by consumers. Again, the consumer may not discover fraudulent activity has occurred, and may not be able to cancel his or her account, until it is too late, and many fraudulent transactions have occurred. This leads to financial loss for the consumer, merchant, issuer, and/or acquirer, and may cause consumers to be reluctant to use payment cards (or other payment devices) to conduct transactions because of the fraud risks involved.

Alternatively, legitimate (non-fraudulent) transactions conducted by the consumer may also be inappropriately flagged as fraudulent activity as occasionally the consumer may make a transaction that does not pass through an existing fraud detection check. In existing fraud detection methods and systems, when this occurs, an issuer of the payment device may automatically decline the transaction or block the account from further transactions, without notifying or asking the consumer if the transaction is authorized. This can be extremely frustrating and confusing for the consumer, who may be unable to conduct a non-fraudulent transaction without calling the issuer to re-activate the account, clarify with the issuer why the transaction was declined, or confirm the transaction is legitimate. In other existing fraud detection methods performed by an automated dialer, issuer, or other entity, there may be steps to automatically notify the consumer when a potentially fraudulent transaction has occurred. However, if a legitimate transaction has been erroneously flagged as fraudulent, the consumer may receive unwanted and repeated notifications from the automated dialer, issuer, or other entity.

Thus, embodiments of the invention provide immediate and accurate detection of fraud when it occurs at the point of sale to prevent significant financial loss to all entities involved. For example, when a payment card has been comprised but the consumer is not aware that it is, it would be advantageous to have a fraudulent transaction being conducted to be instantly flagged as potentially fraudulent, and therefore declined. Then the consumer may be immediately notified that a potentially fraudulent transaction has been made. Or, a legitimate transaction may be inappropriately flagged as potentially fraudulent. Before authorizing and completing the transaction, the consumer may be notified directly (e.g., via telephone call, SMS) requesting a response (e.g., verbal response or text confirmation) to verify that the transaction is intended, and authorize the transaction. The identification and detection of potentially fraudulent and fraudulent transactions may be performed using various algorithms.

Embodiments disclosed herein include improved systems and methods for an automated dialer enhancement. As described above, current systems and methods for fraud detection and notification may be performed by automated dialers. Currently existing automated dialers (1) may not detect all potentially fraudulent transactions, (2) may erroneously categorize a legitimate transaction as a fraudulent transaction, and (3) may not effectively notify the consumer in a manner which resolves the fraudulent transaction. Embodiments disclosed herein address at least these problems, using technology in existing payment transaction processing systems and automated dialer systems. Automated dialer enhancements according to embodiments of the invention provide intelligent and efficient methods to accurately identify potentially fraudulent transactions, reducing the number of fraudulent transactions that pass through typical filters as legitimate transactions and are not flagged as fraudulent. Further processing and analysis of data associated with the identifier potentially fraudulent transaction includes accurately and definitively distinguishing actual fraudulent transactions from the potentially fraudulent transactions, reducing false alarms and false positives. Other embodiments address the problem of effective notification to the consumer once a fraudulent transaction has been detected, so that the consumer is properly informed in a timely manner to take action to prevent further fraudulent activity and protect his or her personal financial data.

The automated dialer enhancement system according to embodiments of the invention comprises of fraud detection systems to analyze transactions, identify potentially fraudulent transactions and eventually determine actual fraudulent transactions. The system may evaluate a transaction using a multitude of rules, scores, other algorithms, and combinations of the above. For example, the evaluation technique may comprise of a detection process that comprises (a) a delta trigger, which may fire or be met if a transaction's score has jumped significantly or exceeds a delta threshold since the last evaluation or within a predetermined amount of time, (b) an immediate trigger, which may fire or be met when a transaction's score exceeds a pre-determined score threshold, or (c) a rules trigger, which is fired or is met whenever a transaction satisfies a particular rule, such as rules that are satisfied when a transaction is a certain type, e.g., “a transaction amount exceeding one million dollars sent to a casino,” or reflects a certain quality.

Further descriptions of certain terms or phrases may be useful.

A “financial transaction” may be any transaction that involves the movement of funds. Examples may include a payment transaction, a request for funds, a transfer of funds, or a deposit of funds. Financial transactions may be conducted with consumers, merchants, banks, issuers, settlement networks, acquirers, payment processing networks, other users, or service providers. A financial transaction may a payment transaction where a consumer pays for goods and services using, e.g., a payment card or other portable consumer device.

A “portable consumer device” may refer to any suitable payment device for conducting payments. Suitable portable consumer devices can be hand-held and compact so that they can fit into a consumer's wallet and/or pocket (e.g., pocket-sized). They may include smart cards, ordinary credit or debit cards (with a magnetic strip), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. Payment devices may be in the form of a card including a credit card, debit card, ATM card, pre-paid card, or charge card. The portable consumer devices can also be debit devices (e.g., a debit card), credit devices (e.g., a credit card), or stored value devices (e.g., a stored value card).

An “account identifier” may refer to an identifier for an account. An account identifier may be in any suitable form. They can be in the form of letters, numbers, etc., and may be of any suitable length. Suitable account identifiers may be in formats associated with payment cards such as credit cards, debit cards, or prepaid cards. Typically, payment card account identifiers may include at least a primary account number (PAN) that is about 16-18 digits in length, and can optionally include a value such as an expiration date or a verification value (a CW or card verification value). The PAN may include a BIN (bank identification number), which is typically six digits long and identifies an issuing institution. The account identifier may be stored on the payment card in a magnetic strip, integrated circuit (IC), or radio-frequency (RF) device. The account identifier may also be printed or embossed on the payment card.

An “access device” may refer to any device that can be used for a consumer and a merchant to interact and make a sale/purchase. For example, an “access device” may be a device located on the premises of a merchant, such as any type of device traditionally used for a card-present transaction. An access device may also refer to a personal computer (PC) of a consumer that is displaying a webpage of a merchant, which may be used for a card-not-present transaction. Examples of “access devices” include point of sale (POS) terminal, an electronic cash register (ECR), a kiosk, an automated teller machine (ATM), a personal computer displaying a website or an application, a device with card reader elements, a mobile device, a mobile or landline phone, or any terminal or device that consumer payment devices and/or account numbers have been traditionally accepted for payment or to conduct other financial transactions.

“Transaction data” may refer to data that is associated with a financial transaction. Transaction data may include data that is present in a typical authorization request message. Such data may include an account identifier (e.g., an account number) that is used to conduct the transaction, the party (e.g., a merchant) with whom the transaction is conducted, a purchase amount, a CVV or dCVV (card verification value) code that is used to authenticate the portable consumer device that is used to conduct the transaction, etc. Transaction data may also include a description of the goods or services purchased, information related to the items to be purchased, or payment amount information (e.g., currency, total or subtotal, tax, and/or shipping) associated with the items purchased. In some cases, transaction data may include a score such as a fraud score associated with a transaction.

A “score” may be a value that is associated with the transaction. Scores can be in any suitable form and may be absolute or relative. Scores can be in the form of letters or numbers (e.g., 10 means “low” and 90 means “high”). A transaction score may relate to a fraud score in some embodiments. A fraud score can be based on characteristics, such as the consumer, the consumer's credit, the consumer's payment history, and/or the types of payment devices used by the consumer. Exemplary scores include credit scores, such as FICO (Fair Isaac Corporation) scores. A credit score may be a number representing the creditworthiness of a consumer, the likelihood that consumer will pay his or her debts. Lenders, such as banks and credit card companies, use credit scores to evaluate the potential risk posed by lending money to consumers. Credit scores are designed to measure the risk of default by taking into account various factors in a consumer's financial history. A transaction score may be calculated or determined by any entity involved in a financial transaction (e.g., issuer, acquirer, payment processing network), or by a third party entity (e.g., Fair Isaac Corporation). Credit and FICO scores are widely accepted and acknowledged by banks, issuers, and acquirers in indicating creditworthiness. Different entities may utilize different formulas, algorithms, factors, and inputs, including a credit (e.g., FICO) score, in determining transaction scores, thus a single transaction may have several different transaction scores associated with it.

An “immediate transaction score” may include a fraud score that is associated with the currently conducted transaction. An immediate transaction score may be a fraud score for a transaction. The fraud score may be based on current transaction information, as well as past transaction data. An exemplary system for determining a fraud score can be found in U.S. Pat. No. 7,809,560, entitled “Method and System for Providing Risk Information in Connection with Transaction Processing,” which is herein incorporated by reference in its entirety. In some embodiments, an immediate transaction score may be determined by a payment processing network using an algorithm based on a specific consumer's buying patterns or personal data.

A “transaction case” may refer to a case for a transaction that is to be evaluated. In some embodiments, a transaction case is an event that is used to determine if a transaction is potentially fraudulent and will require fraud detection and analysis to further identify whether it is an actual fraudulent transaction. The transaction case may comprise transaction data associated with the transaction being conducted. A transaction case may have a status of new, pending, or closed.

A “transaction score delta” may refer to a change in the value of a transaction score (e.g., a fraud score). For example, a transaction score delta may be the difference between a transaction score of current transaction, and a transaction score of a previously conducted transaction. For example, if a fraud score for a transaction that occurred last week is 50 (an example of a second transaction score) and the current transaction score is 75 (an example of a first transaction score), then the transaction score delta is 25.

A “delta trigger” may refer to a rule or condition based on a transaction score delta. For example, in the above example, a delta trigger is “apply additional fraud rules if the transaction score delta is greater than 20.” In the example above, a score delta of 25 would satisfy the delta trigger.

An “immediate trigger” may refer to a rule or condition based on an immediate transaction score. An immediate trigger may be triggered if a single transaction exceeds a score threshold. For example, an immediate trigger may be “apply additional fraud rules if an immediate transaction score is greater than 50.” If the transaction score of the current transaction is 75, then the immediate trigger is satisfied.

A “rule trigger” may refer to a rule or condition that is based on a specific rule. For example, a rule trigger may be “perform additional fraud analysis if the transaction originates from Nigeria.” If the transaction data indicates that the transaction originates from Nigeria, then the rule trigger is met. Various types of rule triggers can be used in embodiments of the invention. Such rule triggers may relate to rules such as the geographic location of a transaction, the transaction amount, the type of merchant, etc.

“Additional processing” may refer to any suitable type of processing. Such processing may include notifying a consumer of a potential case of fraud, blocking an account, applying additional fraud rules, etc.

A “strategy rule trigger” may refer to a condition or rule that can be met by a strategy rule. Strategy rules are determined after analysis of fraud patterns and consumer buying patterns. Therefore if a strategy rule is satisfied by transaction data in the transaction case, the strategy rule trigger is met, thereby indicating a likelihood that the transaction is fraudulent. In some embodiments, a strategy rule trigger may use a location service on the consumer's (e.g., cardholder) mobile phone to be able to define a strategy rule. For example, a strategy rule may trigger when a current card present transaction at a drugstore in San Francisco is conducted and then five minutes later an ATM transaction in New York in conducted. The location service in addition to rule-based triggers would help determine that it is not possible to perform an ATM transaction in New York five minutes after a card present transaction at a drugstore in San Francisco.

A “notification strategy” can refer to a series of steps performed to notify the consumer and optionally request a response from the consumer. A request for a response from the consumer may include additional verification questions, confirming or denying the transaction in question, or acknowledging if the consumer's payment device has been comprised. The consumer may be notified via telephone call, email, SMS, voicemail, interactive voice response, automated dialer, or any other real-time communication means and medium.

An “issuer” may refer to a financial institution, such as a bank, that creates and maintains financial accounts for account holders. An issuer or issuing bank may issue and maintain financial accounts for consumers. The issuer of a particular consumer account may determine whether or not to approve or deny specific transactions. An issuer may authenticate a consumer and release funds to an acquirer if transactions are approved (e.g., a consumer's account has sufficient available balance and meets other criteria for authorization or authentication). The issuer may include a server computer.

An “acquirer” may refer to a financial institution associated with a merchant. Acquirers typically provide merchants with a bank account, and in some cases, transaction accepting infrastructure. Generally, after a transaction has been authorized and as part of the settlement process, funds are transferred from the issuer to merchant's account at the acquirer. Acquirer may also communicate payment transaction status with the merchant. The acquirer may include a server computer.

A “transaction processing system” may include data processing subsystems, networks, and operations used to support and deliver authorization services, exception file services, and clearing and settlement services. An exemplary payment processing system may include VisaDPS™. The transaction processing system may store transaction and account history associated with consumers. When processing a transaction, the transaction processing system may receive transaction data to process transactions, and transaction cases to perform fraud detection. The transaction processing system may perform the triggers and rules described above. There may be multiple transaction processing systems involved to successfully perform accurate and intelligent fraud detection and consumer notification. The transaction processing system may include a server computer.

An “automated dialer” may include data processing subsystems, networks, and operations used to notify consumers of detected fraud. The automated dialer may be incorporated into the transaction processing system or a third party, separate, entity. The automated dialer may include a server computer and other hardware or software to contact consumers via telephone, SMS, email, text messaging, interactive voice response, or other communication means or medium.

An “authorization request message” may be a message that includes an issuer account identifier. The issuer account identifier may be a payment card account identifier associated with a payment card. The authorization request message may request that an issuer of the payment card authorize a transaction. An authorization request message according to some embodiments may comply with ISO 8583, which is a standard for systems that exchange electronic transactions made by cardholders using payment cards. An authorization request message may comprise data elements including, in addition to the account identifier, a service code, a CVV (card verification value), and an expiration date. An authorization request message may also comprise some or all of the information associated with a transaction, such as the “account information” and/or the “transaction information,” as well as any other information that may be utilized in determining whether to authorize a transaction (e.g. a device verification value). An authorization request message may also comprise a device verification value (e.g. a dCW2).

An “authorization response message” may be an issuing financial institution's electronic message reply to an authorization request, which may include one or more of the following status indicators: Approval—transaction was approved; Decline—transaction was not approved; or Call Center—response pending more information, merchant must call the toll-free authorization phone number. It may also include an authorization code, which may be a code that a credit card issuing bank returns in an electronic message to the merchant's POS equipment that indicates approval of the transaction. The code serves as proof of authorization. In some embodiments, a payment processor network may generate or forward the authorization response message to the merchant.

A “payment processing network” may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Authorization, settlement, and clearing may be done at the same time (substantially simultaneously, e.g., within a few minutes or hours) or may be done as part of a batch settlement process (e.g., at the end of the day or week). The payment processing network may include a server computer.

A “server computer” is typically a powerful computer or cluster of computers. For example, the server computer can be a large mainframe, a minicomputer cluster, or a group of server computers functioning as a unit. In one example, the server computer may be a database server computer coupled to a Web server computer. The payment processing network may use any suitable wired or wireless network, including the internet.

### System Overview

In a card-present transaction, since the consumer is in physical possession of the payment card, the merchant can physically examine the payment card, verify identification, and be assured that the consumer is in physical possession of the payment card and is conducting a legitimate (non-fraudulent) transaction. However, with the increased reliance on the Internet and other communication channels, consumers can conduct remote transactions, which can otherwise be referred to as card-not-present transactions. A typical card-not-present transaction may comprise, for example, a consumer making a purchase on a merchant's website. The merchant does not have physical access to the consumer's payment card, and as such, the card is not present at the point of the transaction. Unlike card-present transactions, where the consumer may physically hand the payment card to the merchant for swiping and inspection, a card-not-present transaction typically involves the consumer entering in an account identifier associated with the payment card into the merchant website, or in other examples, such as a phone transaction, keying in or speaking the account identifier.

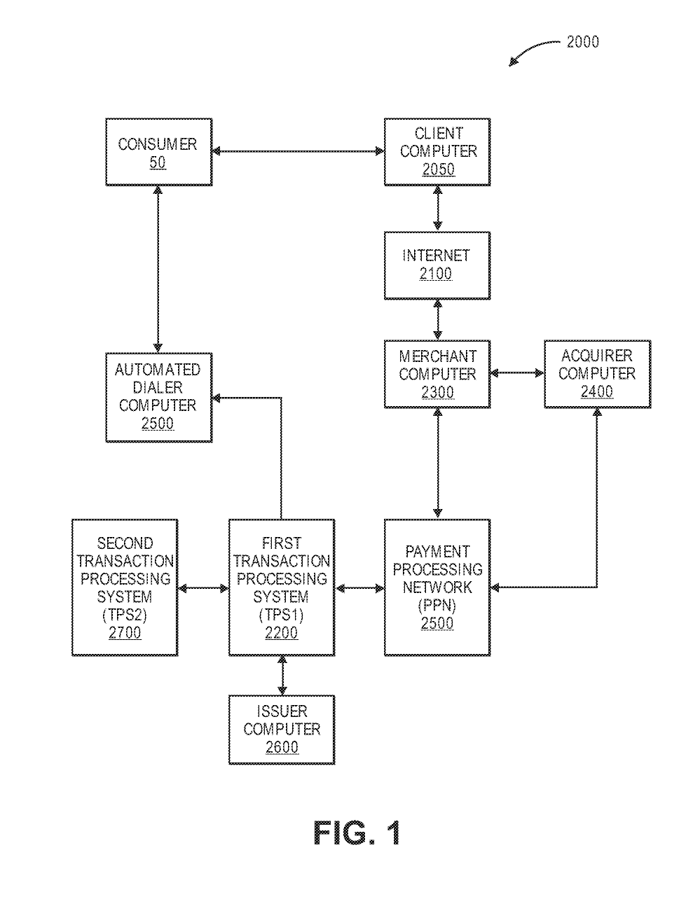

FIG. 1 shows an exemplary system diagram according to an embodiment of the invention for a card-not-present transaction. Consumer 50 may access the Internet 2100 via a client computer 2050 (e.g., a personal computer). In other embodiments, the consumer 50 may access the Internet 2100 through a mobile device such as a tablet or cellular phone. The consumer 50 may visit a merchant website operated by a merchant computer 2300. When the consumer 50 conducts a transaction on the merchant website, for example, to purchase items using an account identifier from a payment card, the merchant computer 2300 may electronically transmit transaction data to an acquirer computer 2400. Simultaneously, the transaction data may be electronically transmitted to a payment processing network (PPN) 2500, such as Visa.

The transaction data may include the account identifier from the payment card, purchase amount, items purchase, and other consumer information (e.g., billing address, phone number, etc.). In other embodiments, the transaction data may be only the information included in an authorization request message. The payment processing network 2500 may then forward the transaction data to a first transaction processing system (TPS1) 2200. The first transaction processing system 2200 may initiate authorization of the transaction, by sending the transaction data in an authorization request message, to an issuer 2600. TPS1 may also forward the transaction data to a second transaction processing system (TPS2) 2700, for initial potential fraud analysis. TPS1 2200 may transmit the transaction data to TPS2 2700 in parallel with the authorization request message to the issuer 2600, or the transmission may occur at different times.

TPS2 2700 performs initial potential fraud detection and if potential fraud is detected, creates a transaction case, using the transaction data. The transaction case is transmitted back to TPS1 2200 for further fraud detection to determine whether it is actual fraud. In other embodiments, TPS2 2700 may perform the further fraud detection, or alternatively, TPS1 2220 may perform both initial potential fraud detection and further fraud detection. In another embodiment, the payment processing network (PPN) 2500 may perform one or all the tasks of either TPS1 2200, TPS2 2700, or both.

In the scenario that the transaction case is determined to be actual fraud, or in the process of determining whether the transaction case is actual fraud, the consumer may be notified. TPS1 2200 may be operatively coupled to an automated dialer 2500 and transmit a message to the automated dialer 2500 to contact the consumer 50 via email, telephone call, interactive voice response, SMS, or other communication means. In other embodiments, TPS2 2700 may transmit the message to the automated dialer 2500. In another embodiment, PPN 2500 may transmit the message to the automated dialer 2500 to contact the consumer 50.

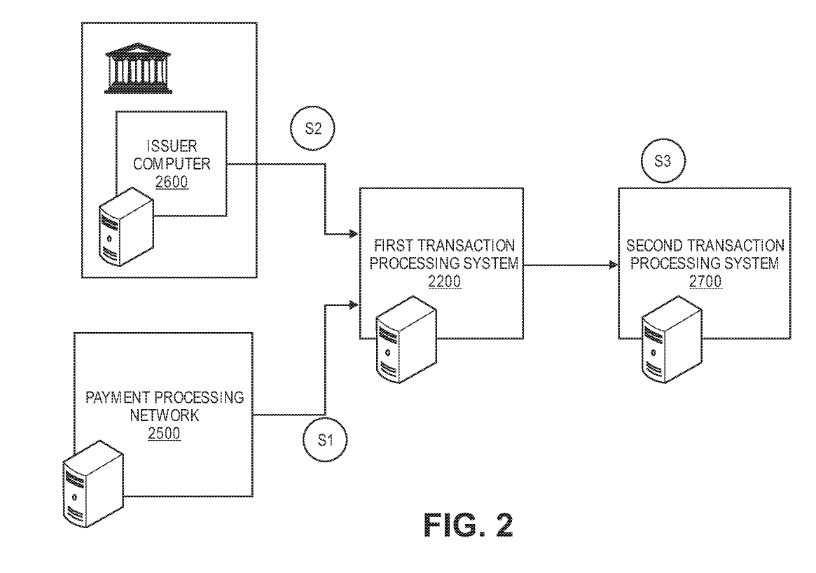

FIG. 2 shows a system flow diagram according an embodiment of the invention in determining a transaction is a potentially fraudulent transaction, thus creating a transaction case. In step S1, the payment processing network 2500 (e.g., VisaNet) may transmit to the first transaction processing system 220 transaction activity for a transaction, including payment device data, associated account identifier, etc. Thus, TPS1 2200 receives transaction data for a current transaction from the payment processing network 2500.

In step S2, an issuer of the payment device for the consumer may operate an issuer computer 2600 containing batched transaction history associated with the payment device and its associated account identifier. The issuer may transmit the batch file containing the related transaction history to TPS1 2200.

In step S3, the transaction data associated with the current transaction transmitted by the PPN 2500 (in step S1), and the batched transaction history associated with the payment device transmitted by the issuer 2600 (in step S2) are transmitted to the second transaction processing system 2700. TPS2 2700 performs initial potential fraud analysis, and determines whether the current transaction is potentially fraudulent. If the transaction is determined to be potentially fraudulent, TPS2 2700 creates a transaction case for further fraud detection.

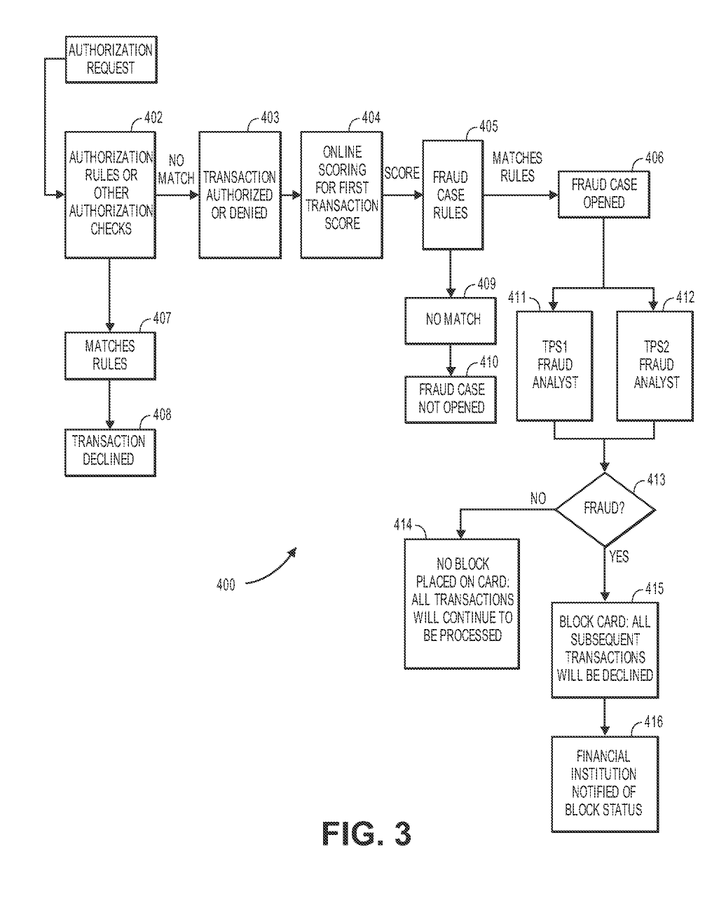

The case creation flow is illustrated in more detail in FIG. 3, and includes further fraud detection and notification. Referring to FIG. 3, steps 401 through 406 illustrate case creation in detail, which was also shown in FIG. 2. In step 401, an authorization request is created when a consumer wishes to conduct a transaction, for example, online on a merchant website from his or her client computer. The merchant website may be operated on a merchant computer, which may form an authorization request message comprising transaction data associated with the transaction. In steps 402, the transaction data in the authorization request may go through authorization rules or other authorization checks. This may be performed by an issuer of the payment card used in the transaction. In step 407, if the transaction data in the authorization request message matches certain authorization rules, then the transaction is declined in step 408, and the transaction does not proceed any further. For example, if an account identifier associated with the payment card used to conduct a transaction has already been canceled or blocked, the transaction will automatically be declined upon receipt of the authorization request message checked again authorization rules.

However, if the transaction data in the authorization request message does not match authorization rules, then it may be determined whether to authorize or deny the transaction, as shown in step 403. This may be performed by the issuer of the payment card, or the payment processing network. When the transaction has been denied at step 403, it may be because a purchase amount in the transaction data for the transaction exceeds a credit limit for the payment card, thus is may or may not be fraudulent. Therefore, in embodiments of the invention illustrated in FIG. 3, transaction data, regardless of whether the transaction is authorized or denied, is processed for online scoring for a first transaction score. As shown in step 404, a fraud evaluation is performed for the transaction. Thus, the denial of the transaction (in step 403) is distinguished from the declination of the transaction (in step 408), in that a denied transaction may still continue to be processed to determine whether it is fraudulent or not, and in a denied transaction, the consumer may be given an opportunity to provide another payment card or other alternative to continue the transaction. A declined transaction does not continue to proceed any further.

In step 404, a first transaction score is determined for the associated transaction. A first transaction score may be a credit score, such as a FICO score. The first transaction score may be a transaction score generated by a transaction processing system. In an embodiment shown in FIG. 3, the first transaction score may be a transaction score generated by a first transaction processing system. The transaction score may provide an indication of fraud probability for each individual transaction. An exemplary transaction score may have a value that ranges from 0 to 999. In this example, if the transaction score is higher, the fraud is more likely to be present.

The transaction score may be an evaluative score which reflects the probability of the transaction matching a certain quality or criteria. An example of a score may include a score for a transaction reflecting whether it is fraudulent or not. Other qualities may comprise of scores describing likelihood of the type of purchase, e.g., “transaction is purchase for food,” “transaction is a purchase for entertainment,” etc. Other qualities may reflect the relationship between the merchant and the consumer, such as determining if the transaction was sent to a local small business, etc.

The transaction score is then processed by a transaction processing system to determine whether it is potentially fraudulent or not, by checking the transaction score against fraud case rules, as shown in step 405. Referring to FIG. 2, steps 405, 406, 409, and 410, may be performed in a second transaction processing system (TPS2). Fraud case rules are run against all transactions, regardless of whether it is authorized or denied, to determine whether the transaction is potentially fraudulent. If the transaction case meets fraud case rules, meaning it is potentially fraudulent, a fraud case is created and opened, as shown in step 406. For example, a fraud rule may be if a first transaction score exceeds a threshold transaction score. Therefore, if an exemplary transaction score may be a value between 0 to 999, with a higher score indicating a higher probability of fraud, a threshold transaction score may be set to 700. In a transaction with a first transaction score of 800 exceeds the threshold, indicating that it is potentially fraudulent. The transaction may be run against one or more fraud case rules to determine whether to create a fraud case or not.

In step 409, if the transaction does not meet the fraud case rules, for example, if the first transaction score is 450, then the transaction is determined to not likely be fraudulent, and a fraud case is not opened, as shown in 410.

When a fraud case is opened, the fraud case, comprising transaction data for the current transaction, may be sent to a transaction processing system for fraud analysis. In embodiments of the invention where there is a first transaction processing system and a second transaction processing system, the fraud case may be forwarded to a TPS1 (step 411) and TPS2 (step 412) for fraud analysis. In other embodiments, there may be only one transaction processing system performing fraud analysis.

In step 413, after the fraud analysis has been performed, the transaction processing system or systems (e.g., TPS1 and TPS2) conclude whether fraud has been detected. If the fraud case has been determined to not be fraudulent, then in step 414, no block is placed on the payment device, and all transactions using the payment device may continue to be processed. However, in step 415, if the fraud case has been determined to be fraudulent, then the payment device is blocked, and all subsequent transaction using the payment card and its associated account identifier will be declined. Additionally, in step 416, a financial institution or bank, such as an acquirer, will be notified of the block status on the payment device.

Therefore, for example, if the same payment device is used in another transaction again after it has been determined the previous transaction was fraudulent, it will be run against the authorization rules and checks in step 402, match the rule that the payment device matches one flagged as fraudulent (step 407), and the transaction will be declined (step 408).

In some embodiments, the automated dialer enhancements improves the precision of fraud analysis by performing multiple checks and incorporating both rule and points triggers. This may result in the more rapid triggering and detection of certain transaction qualities. In an example embodiment, a payment processing network may execute automated dialer enhancements to reduce the chance of fraud by checking the transaction fraud detection score delta, the transaction fraud detection score value, and rules that may apply to the transaction. The owner of the account may be notified of the potential fraud and the block may be placed on the account to prefer future potential fraudulent transactions. The payment processing network may receive the case transaction from an issuer.

In an example embodiment, the automated dialer enhancements system addresses the ability to utilize defined transaction and attributes where suspected fraud is occurring and immediately notify the consumer and place a discretionary block on the consumer's payment card to prevent further authorizations. A virtual analyst may perform the appropriate contact to the consumer. A rule and point trigger based system may provide a more granular approach to preventing fraud or detecting other qualities and attributes of transactions.

The automated dialer enhancements may be implemented in a payment processing network, one or more transaction processing systems, or a third party system (e.g., automated dialer). The criteria that define the triggers may be provided by the payment processing network, one or transaction processing system, the issuer, the acquirer, or the consumer.

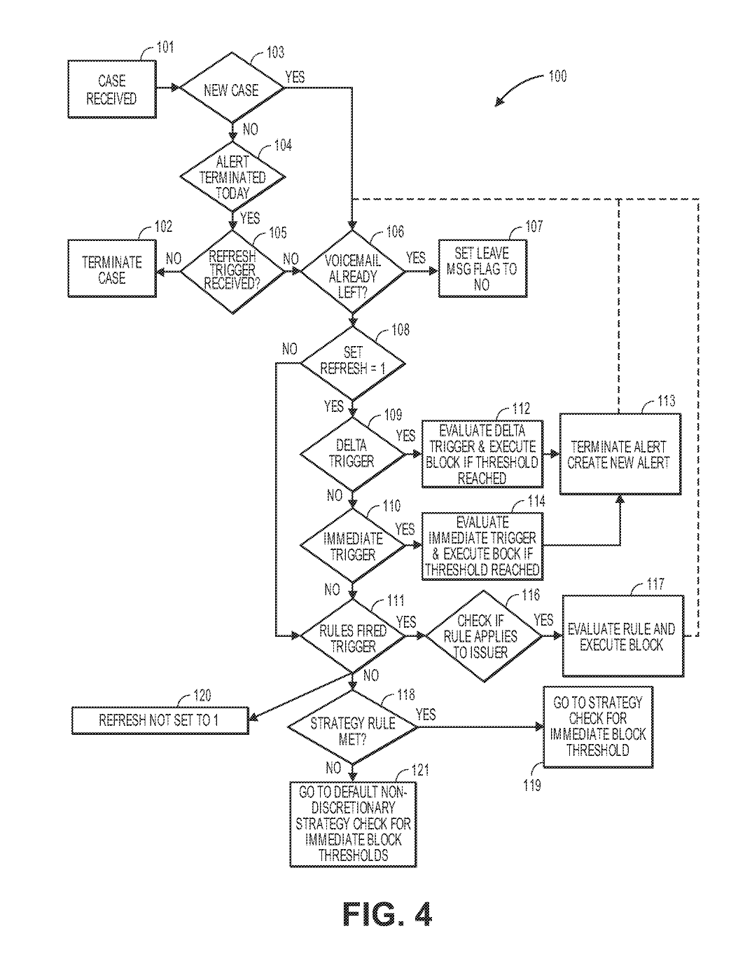

FIG. 4 is a flow diagram illustrating case flow management with multiple triggers, according to an example embodiment. The flow begins with a transaction processing system receiving the case at step 101. The case may include transaction data comprising the customer portable consumer device (e.g., payment card), the merchant, the transaction amount, the time and location of the transaction, etc. The status of the transaction case is checked in step 103, and if it is not a new case (e.g., duplicate transaction case), then an alert to terminate the duplicate case is sent (step 104), and the transaction case is checked whether the status is refreshed by performing a refresh trigger (step 105). If the transaction case has not been refreshed, then it is confirmed that the transaction case is currently being processed and the duplicate case will be terminated (step 102). However, if the transaction case has been refreshed (e.g., existing transaction case in fraud analysis process), then the transaction processing system checks whether the consumer has been contacted with a voicemail regarding the potentially fraudulent transaction (step 106). If a voicemail has already been left for the consumer regarding the potentially fraudulent transaction, then the transaction processing system records that the consumer has already been contacted by setting a “LEAVE MSG” flag to NO (step 107).

In the scenario in step 103 the case is determined to be new, then the transaction processing system will first check whether the consumer has been contacted previously in step 106. Again, if yes, then in step 107 the TPS sets the “LEAVE MSG” flag to NO.

In both scenarios of new or refreshed transaction cases where no voicemail has been left (in step 106), then the transaction processing system proceeds to step 108, in first setting the refresh trigger to 1. Then three triggers may be applied: a delta trigger (step 109), a immediate trigger (step 110), and a rules fired trigger (step 111).

In step 112, the delta trigger may evaluate a first transaction score associated with the current transaction and a second score since the last refresh was set. The delta trigger may be a score based trigger based on a transaction score delta. The last refresh may be the previous transaction or the last time a score was provided. The last refresh score may be attributed to the same consumer or portable consumer device for a different transaction. If the transaction score delta between the second transaction score and the first transaction score exceeds a threshold transaction score delta, then the delta trigger may fire or be met. For example, if the score of a credit card last time it was used was 500, and it currently has a score of 900, the transaction score delta would be 400. If the threshold transaction score delta is 300, then the delta trigger would be satisfied. In an example, the scores may represent the likelihood of fraud and the trigger may fire or be met if the transaction suddenly represents a spike in the risk.

If the delta threshold is exceeded, then the system may evaluate whether a block should be placed on the account. The current alert may then be terminated and a new alert created, as shown in step 113. The new alert may inform the system to leave a voice mail or engage in notification, or other actions, as shown by the dotted line back to step 106. In one embodiment of the invention, the consumer may be notified, but if a voicemail has already been left, the transaction processing system may not leave a second voicemail. If no response to the initial voicemail is received at that point, then it may be implicitly determined that the consumer does not find the transactions he or she is being notified about as being fraudulent.

In another embodiment, there may be a delta case re-activation threshold, which is a value assigned to alert the transaction processing system to reactivate unblocked transaction cases closed as unconfirmed fraud or with a status of pending. The delta case re-activation threshold may be the difference between an original highest score and a more recent highest score. Once the delta re-activation threshold has been reached, the transaction processing system may review subsequent activity on the consumer portable device.

If the delta trigger is not fired or met, the system may then evaluate an immediate trigger (step 110). An immediate trigger may also be a score based trigger. In step 114, an immediate trigger may evaluate an immediate transaction score in order to determine whether the immediate trigger is met. For example, if an immediate transaction score of a current transaction exceeds an immediate transaction score threshold, then the immediate trigger may automatically fire or be met. In one example, an immediate transaction score may be a value between 0 and 999, which a higher value indicating a higher probability of fraudulent activity, and an immediate transaction threshold may be 950. Thus, if the immediate transaction score for the current transaction score is 975, then the immediate transaction threshold is exceeded, and the system may evaluate whether a block should be placed on the account. The current alert may then be terminated and a new alert created (step 113). The new alert may inform the system to leave a voice mail or engage in notification, or other actions.

If the immediate trigger is not fired nor met, the system may then evaluate a rules fired trigger (step 111). The rules fired trigger is a rules based trigger and analyzes qualities of the transaction, rather than a score. The rules fired trigger may analyze the transaction to determine if it satisfies a particular rule, for example, by checking if the rule applies to an issuer identifier for the client (step 116). The rules may focus on specific qualities of the transaction, such as the transaction amount, where the money is being sent, where the money is being sent from, or a combination of factors. If the rule is triggered, then the system may evaluate whether a block should be placed on the account (step 117). The current alert may then be terminated and a new alert created. The new alert may inform the system to leave a voice mail or engage in notification, or other actions.

The flow may then flow to the strategy rule decision block (step 118), and the refresh is not set to 1, as shown in step 120 A strategy rule is met then transaction data associated with the transaction case meet requirements specified by pre-determined criteria of the strategy rule. A strategy rule may be based on fraud patterns and buying patterns of the consumer, and may be determined by the payment processing network, transaction processing network, or third parties. Transaction history may be stored in a database associated with the payment processing network, transaction processing network, or other party, and analyzed to determine fraud and buying patterns. The actions may include further steps to be taken in order to address the scores or qualities that fired or meets the triggers. The actions may include sending notifications to various entities, communicating the results with other fraud detection systems, or reversing various transactions. When the strategy rule has been met, the transaction processing system may perform additional processing, such as performing strategy checks for an immediate block threshold, as shown in step 119. In an example embodiment, the actions may conduct auto-resolution of the transaction.

If the strategy rule is not met, then in step 121, default non-discretionary strategy checks for immediate block thresholds are performed. For example, non-discretionary strategy checks include the issuer allowing the transaction processing system to block the payment device and associated card based upon any of the triggers met, and a manual fraud analyst is not needed to review the case history before blocking the payment device. In discretionary strategy checks (as shown in step 119), all case activity is reviewed, and regardless of what triggers have been satisfied, a manual fraud analysis is conducted by a person to determine conclusively whether the transaction case is fraudulent or not.

### Exemplary Triggers

Exemplary different triggers according to embodiments of the invention are described in more detail. When an client sends account information for their third party application to work on, a transaction case may be created by the transaction processing system or one of the transaction processing systems (TPS1 or TPS2). The case may be used to track and organize alerts that the transaction processing system processes in an effort to contact the consumer and resolve the account over a period of time.

Normally, an alert may “go to sleep” for a configured period of time if it cannot immediately proceed with a resolution attempt (e.g., outside of consumer contact window). When the alert “wakes up” it may update its data before it begins to process again. The act of the alert updating its data is known as a “refresh”.

Should the transaction processing system have a transaction case requiring more immediate action, for example, TPS1 can send a “refresh trigger” to TPS2, or payment processing network. The refresh trigger may wake up the case's sleeping alert and a refresh will be performed which will then take the new data into consideration to determine if a change is required such as a different contact strategy or an alternative voice treatment.

A good example of a refresh trigger situation is a fraud scenario in which a bank processes a questionable transaction to a consumer's payment card with a higher fraud score than previous transactions sent to a transaction processing system for that case. For example, the acquirer (e.g., bank) may send a refresh trigger to the TPS (either TPS1 or TPS2) to force a refresh and determine if the case should be worked more aggressively.

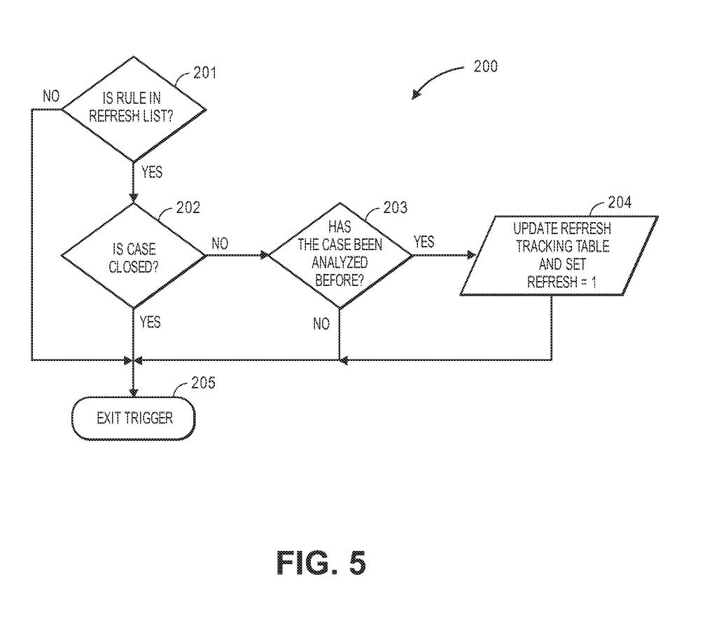

Another exemplary trigger is a rule trigger. FIG. 5 is a flow diagram illustrating rule based trigger logic, according to an example embodiment. This flow diagram illustrates that, in a rule based trigger system, that when a transaction or case that triggers a rule in the refresh list (step 201), which is not closed (step 202) and has been analyzed before (step 203), can be marked to so that the system knows it has been refreshed. Refreshing a case or transaction may indicate that, prior to the case being close, another transaction or event was detected by the rule based system. The refresh market may indicate to the system that additional activity has occurred and that escalated actions may be justified. For example, if a prior transaction was noticed by the system and notifications were sent, but the case was not closed and a later transaction again fires the triggers, the refresh value may be set to one in order to escalate the case/transaction (step 204). If either the transaction case is determined to be closed (step 202), or the case has not been analyzed before (step 203), or the rule is not in the refresh list (step 201), then the transaction processing system will exit the rule triggers (step 205).

In some embodiments of the invention, a strategy rule trigger may use a location service on the consumer's (e.g., cardholder) mobile phone to be able to define a strategy rule. For example, a fraud rule strategy may trigger when a current card present transaction at a drugstore in San Francisco is conducted and then five minutes later an ATM transaction in New York in conducted. The location service in addition to rule-based triggers would help determine that it is not possible to perform an ATM transaction in New York five minutes after a card present transaction at a drugstore in San Francisco.

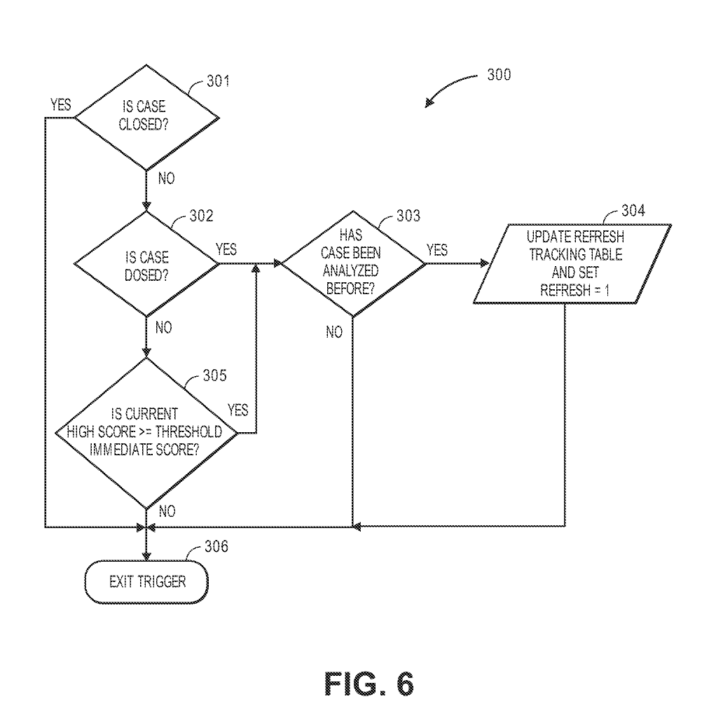

Another exemplary trigger includes a score based trigger, such as a delta trigger or an immediate trigger. FIG. 6 is a flow diagram illustrating score based trigger logic, according to an example embodiment. This flow diagram illustrates, that in a point based trigger system, that when a transaction case is determined to not be closed (step 301), a transaction score delta may be determined based on a transaction score of the current transaction compared to a previous transaction score, and the transaction score delta Is checked whether it is greater than a transaction score delta threshold, for example, a configured score delta (step 302). If the configured score delta has been exceed, then the transaction case is checked whether it has been analyzed before, as shown in step 303. If the transaction case has been analyzed before, then the transaction case can be marked to so that the system knows it has been refreshed, as shown in step 304. In a scenario that the transaction delta score threshold is not exceeded, then the transaction case is checked against an immediate trigger, shown in step 305, where an immediate transaction score is evaluated and determined whether it exceed an immediate score threshold, for example, a configured immediate score (step 305). If the transaction case is closed (step 301), or the transaction case immediate score does not exceed the configured immediate score (step 305), or the case not been analyzed before, then the transaction processing system may have the transaction case exit the trigger (step 306).

### Notification Strategy and Additional Processing

If any of evaluation processes test positive, then the transaction case may be determined as fraudulent, then a notification strategy and/or additional processing may be performed (e.g., blocking an account associated with the payment device used in the transaction). For example, if one or more of the above triggers, either the delta trigger, immediate trigger, rules trigger, or strategy trigger, are satisfied, then the automated dialer enhancements system according to embodiments of the invention may execute a notification strategy. An exemplary notification strategy may dictate that a notification be sent to the consumer via various channels and means, comprising e-mail, telephone, SMS, etc. In an example embodiment, a consumer may be notified via phone/voicemail. The notification strategy may also determine which entities are notified. Such entities may include an issuer, a bank, a consumer, an account holder, a telephone number, etc. In an example embodiment, the account funding of the transaction may be blocked. In an further embodiment, the account of the transaction may be blocked only if no response to the notification is received within a pre-defined period of time. The blocking of the account may reduce the chance that an account may be used to fund later fraudulent transactions.

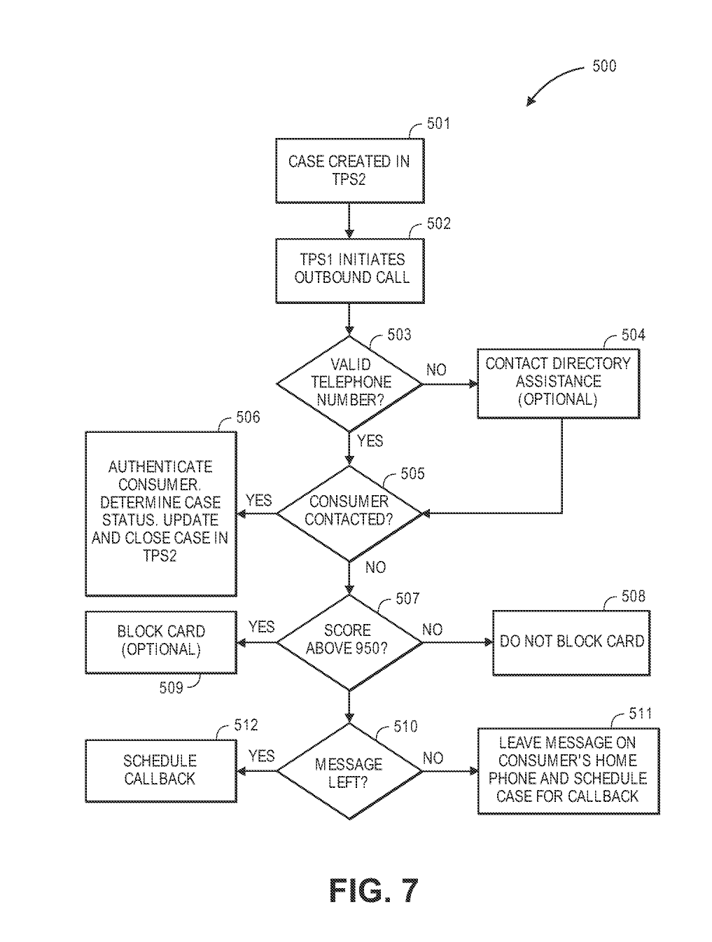

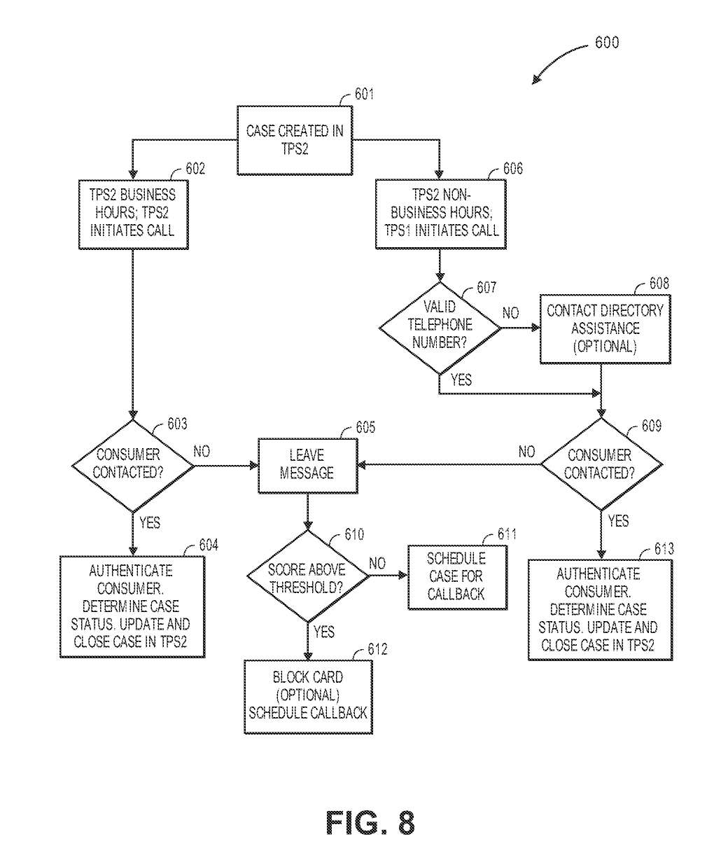

FIGS. 7 and 8 show flow diagrams for exemplary notification strategies according to embodiments of the invention. FIG. 7 shows a flow diagram illustrating a notification strategy according an exemplary embodiment. After a transaction case is created (step 501) and received by a transaction processing system, such as TPS2, then in step 502, TPS1 may initiate an outbound call to the consumer. In step 503, TPS1 determines whether a phone number on file associated with the consumer is valid. If the phone number is not valid, then TPS1 may contact directory assistance in step 504. When a valid phone number for the consumer is obtained, then the consumer is contacted in step 505. In step 506, when the consumer is reached, the consumer may authenticated and requested to confirm whether the transaction is legitimate or fraudulent. Thus the status of the transaction case is determined by communicating with the consumer, the status may be updated to the case, and the transaction case may be closed in TPS2 (step 506).

If the consumer (e.g., cardholder) is not contacted in real-time, then in step 507, the transaction score may be evaluated and checked whether it is above a threshold (e.g., 950 on a scale of 0 to 999), such as in an immediate trigger, thereby determining the probability of the transaction being potentially fraudulent. If the transaction score does not exceed the transaction threshold, then in step 508, a payment device associated with the transaction case is not blocked. However, if the transaction score does exceed the threshold transaction score, then the payment device (e.g., payment card) may be blocked from conducting further transactions (step 509). This temporary block may be performed as a precaution to prevent other potentially fraudulent transactions. The temporary block may be lifted when the transaction case has been confirmed by the consumer that it is legitimate. In both scenarios, whether the transaction score exceeds the threshold score or not, TPS1 may determine whether a message has been left for the consumer (step 510). If a message has been left, then TPS1 may schedule another callback with the consumer in step 512 without leaving a new message. If a message has not been left, then TPS1 may leave a message for the consumer and schedule a callback, as shown in step 511.

In FIG. 8, another exemplary notification strategy according to another embodiment of the invention is illustrated. A transaction processing system, such as a second transaction processing system (e.g., TPS2), may determine a potentially fraudulent transaction and create a transaction case in step 601. Either of the transaction processing systems may receive the created transaction case. If the transaction occurs during the hours of business operation for TPS2, then TPS2 may initiate a call to the consumer in step 602. The consumer is contacted in step 603, and if the consumer is reached, then in step 604, the consumer may be authenticated, requested to confirm whether the transaction is legitimate or not, and the status of the transaction case may be updated (e.g., closed) with TPS2. If the consumer is not reached, then TPS2 may leave a message with the consumer in step 605. A transaction score may be determined and evaluated whether it exceeds a threshold transaction score (step 610), for example an immediate trigger according to embodiments of the invention. If the transaction score is not above the threshold transaction score, then TPS2 may schedule a callback to the consumer for an update in step 611. If the transaction score exceeds the threshold transaction score, then TPS2 may block a payment device (e.g., payment card) associated with the transaction case and schedule a callback to the consumer, as shown in step 612.

After the case is created in step 601 and the transaction occurs outside of TPS2 normal business hours, then TPS1 may initiate a call to the consumer in step 606. In step 607, TPS1 determines whether a phone number on file associated with the consumer is valid. If the phone number is not valid, then TPS1 may contact directory assistance in step 608. When a valid phone number for the consumer is obtained, then the consumer is contacted in step 609. In step 613, when the consumer is reached, the consumer may authenticated and requested to confirm whether the transaction is legitimate or fraudulent. Thus the status of the transaction case is determined by communicating with the consumer, the status may be updated to the case, and the transaction case may be closed in TPS2 (step 612).

If the consumer (e.g., cardholder) is not contacted in real-time, a message may be left for the consumer in step 605, and then in step 610, a transaction score may be evaluated and checked whether it is above a threshold (e.g., 950 on a scale of 0 to 999), such as in an immediate trigger, thereby determining the probability of the transaction being potentially fraudulent. If the transaction score does not exceed the transaction threshold, then in step 611, TPS1 may schedule a callback to the consumer. However, if the transaction score does exceed the threshold transaction score, then the payment device (e.g., payment card) may be blocked from conducting further transactions (step 612), and a callback to the consumer is scheduled. This temporary block may be performed as a precaution to prevent other potentially fraudulent transactions. The temporary block may be lifted when the transaction case has been confirmed by the consumer that it is legitimate.

Embodiments of the invention may further include additional processing. A refresh trigger may affect the processing of a specific case in a specific application for a consumer. Acting on current data (e.g., making a proactive call sooner, or avoiding an unnecessary call) may be more effective in notifying consumers and successfully garnering a response. In some embodiments, a refresh trigger can result in a change in a notification strategy that could be viewed either as an escalation or as a downgrade in priority. This is expected behavior since it reflects the reality of the data contained in the refresh trigger. Implementation of the notification strategy depends the interface of the transaction processing system with the consumer, for example, through an automated dialer. A real-time integration for real-time, immediate communication to the consumer is critical to the efficacy and advantages of the notification strategy.

In an embodiment of the invention, a transaction case may be blocked when a score-based trigger or rule trigger has been satisfied. Today most issuers have set score thresholds with which to place a block should the consumer not be reached in person. These score thresholds vary but are generally at the score of 950 in a scale of 0 to 999, which higher transaction scores indicating a higher probability of fraud. With the real-time notification strategy, there may be scores generated by rules that do not meet the block threshold but have a low false positive indicating a high likelihood of fraud. Based upon the rule that fired, the case can optionally be blocked even if the score did not reach the threshold.

### Other Embodiments

In another embodiment of the invention, the transactions analyzed by the automated dialer enhancement system and methods may use various types of value. Value may comprise of types such as traditional currencies, e.g., USD, RMB, but may also include other units of value, such as cell phone minutes, online currencies, digital points, and other digital micro-credits. For example, the system may analyze transactions using value in the form of Facebook™ Coins or Zynga™ Cash or Coins. The transaction analyzed may comprise of traditional payment card transactions, value transfers, check transactions, etc.

In another embodiment of the invention, the transaction processing system, or other entity used to contact consumers regarding suspected fraud cases may provide the following optional features, such as multiple choice tokens and optional authentication tokens. Multiple-Choice Tokens may offer consumers multiple-choice authentication questions. Optional Authentication Tokens may allow issuers, payment processing networks, or transaction processing networks to specify which authentication tokens to present to their consumers when contacted on outbound calls placed by the dialer.

In other embodiments of the invention, the system may offer the cardholder multiple choice authentication questions. Since consumers may become suspicious of entering their personal data, this optional feature will allow issuers at the processor level to instead offer multiple-choice questions to the consumer. For example, the consumer may be asked to select one of four choices for a ZIP code to authenticate. The four ZIP codes are all within the same city/state region and one of the four choices will be the correct ZIP code as recorded. In addition, once consumers pass the authentication phase, they continue through the entire fraud detection analysis (e.g., score-based triggers and rule triggers), which improves the transaction processing system's ability to manage suspected fraudulent activity.

An Optional Authentication Token allows each entity (e.g., issuer, payment processing network, acquirer, transaction processing system) to specify which authentication tokens to present to the consumer on outbound calls placed by an automated dialer, or other entity. This token may allow an issuer to select 1 or all 3 of the tokens to be presented. Whatever tokens are selected will be presented to all cardholders and they must pass the tokens selected. For example, instead of requiring ZIP code and last 4 of the SSN, the issuer may elect to only require the ZIP code. Issuers may combine the Optional Token enhancement with the Multiple Choice enhancement.

### ADVANTAGES

Embodiments of the invention have many advantages. embodiments of the invention provide immediate and accurate detection of fraud when it occurs at the point of sale to prevent significant financial loss to all entities involved. For example, when a payment card has been comprised but the consumer is not aware that it is, it would be advantageous to have a fraudulent transaction being conducted to be instantly flagged as potentially fraudulent, and therefore declined. Then the consumer may be immediately notified that a potentially fraudulent transaction has been made. Or, a legitimate transaction may be inappropriately flagged as potentially fraudulent. Before authorizing and completing the transaction, the consumer may be notified directly (e.g., via telephone call, SMS) requesting a response (e.g., verbal response or text confirmation) to verify that the transaction is intended, and authorize the transaction. The identification and detection of potentially fraudulent and fraudulent transactions may be performed using various algorithms.

Currently existing automated dialers (1) may not detect all potentially fraudulent transactions, (2) may erroneously categorize a legitimate transaction as a fraudulent transaction, and (3) may not effectively notify the consumer in a manner which resolves the fraudulent transaction. Thus, in advantages of embodiments disclosed herein include addressing at least these problems, using technology in existing payment transaction processing systems and automated dialer systems.

Automated dialer enhancements according to embodiments of the invention provide intelligent and efficient methods to accurately identify potentially fraudulent transactions, reducing the number of fraudulent transactions that pass through typical filters as legitimate transactions and are not flagged as fraudulent. Accurately detecting fraudulent transactions reduces financial losses for all entities involved, and protects the consumer from continued fraudulent transactions. An advantage of embodiments of the invention includes reduced fraudulent transactions and reduced financial loss.

Further processing and analysis of transaction data associated with the potentially fraudulent transaction includes accurately and definitively distinguishing actual fraudulent transactions from the potentially fraudulent transactions, reducing false alarms and false positives. False alarms of fraudulent transactions that are legitimate costs payment processing networks and transaction processing networks money and time to analyze the transaction data. Thus, further advantages include reduced operating costs for the payment processing network and transaction processing system.

Other advantages provided by embodiments of the invention address the problem of effective notification to the consumer once a fraudulent transaction has been detected, so that the consumer is properly informed in a timely manner to take action to prevent further fraudulent activity and protect his or her personal financial data. Immediately notifying the consumers, prevents further fraudulent activity on the payment device, providing another advantage of embodiments of the invention. Thus, embodiments of the invention provide efficient, effective, and real-time notification to the consumer.

Another advantage of embodiments of the invention include precautionary prevention of fraudulent activity by placing a temporary block on a payment device associated with an identified potentially fraudulent transaction. The block can be lifted when it has been confirmed that the transaction is not fraudulent. However, if the transaction is fraudulent, even before the consumer is notified, the payment device is blocked from immediate fraudulent activity that may occur very quickly before fraud analysis has been completed.

### EXEMPLARY SYSTEMS

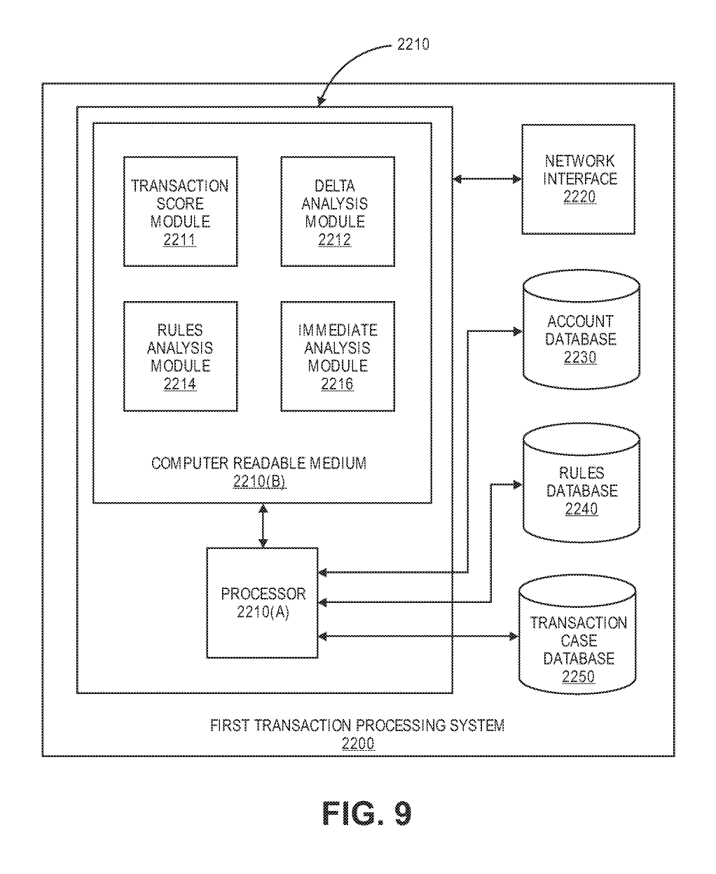

Payment processing networks and transaction processing systems according to embodiments of the invention may include a server computer comprising a processor and a non-transitory computer-readable medium. The non-transitory computer-readable medium may comprise code executable by the processor to perform methods, such as the triggers and flows described in the FIGs. FIG. 9 shows a block diagram illustrating an exemplary first transaction processing system 2200. TPS1 may comprise a server computer 2210 comprising a processor 2210 (a) and a computer-readable medium 2210(b). There may be code modules stored in the non-transitory computer-readable medium. For example, there may be a transaction score module 2211 to evaluation transaction scores for a transaction, where the transaction scores are used to score-based triggers (e.g., delta triggers and immediate triggers) discussed previously. When a transaction score has been determined, a delta analysis module 2212 may evaluate a transaction score delta between a transaction score of a current transaction and a transaction score of a previous transaction. The delta analysis module 2212 may also determine a threshold transaction score delta, and determine whether the transaction score delta meets the threshold transaction score delta, thereby triggering the immediate trigger. An immediate analysis module 2216 may determine an threshold immediate score, and whether an immediate transaction score meet the threshold immediate score, thereby triggering the immediate trigger. A rules analysis module 2214 may determine, from a set of rules stored in a rules database 2240 coupled to the processor 2210(a), whether the transaction satisfies the rule trigger.

The processor 2210(a) may be coupled to the rules database 2240, comprising stored rules and strategy rules used to determine a rule trigger or a strategy rule trigger, respectively. The processor 2210(a) may also be coupled to a transaction case database 2250, comprising stored transaction data associated with transaction cases. The stored transaction data may be analyzed by the rules analysis module 2214 to determine fraud and buying patterns, determining strategy rules based on the fraud and buying patterns, and determining strategy triggers. The strategy rules may then be stored in the rules database 2240. The processor 2210(a) may also be coupled to an account database 2230, comprising consumer data, including payment device data (e.g., account identifiers), and consumer phone numbers. The first transaction processing system 2200 may use the processor 2210(a) to access the account database to determine the payment device (e.g., payment card) and associated consumer phone number, to perform additional processing, such as notifying the consumer at the store phone number, or blocking the stored payment device. The first transaction processing system 2200 may also comprise hardware, such as a network interface 2220, to communicate with other entities, for example, the consumer, issuer, acquirer, merchant, payment processing network, automated dialer, or other transaction processing systems.

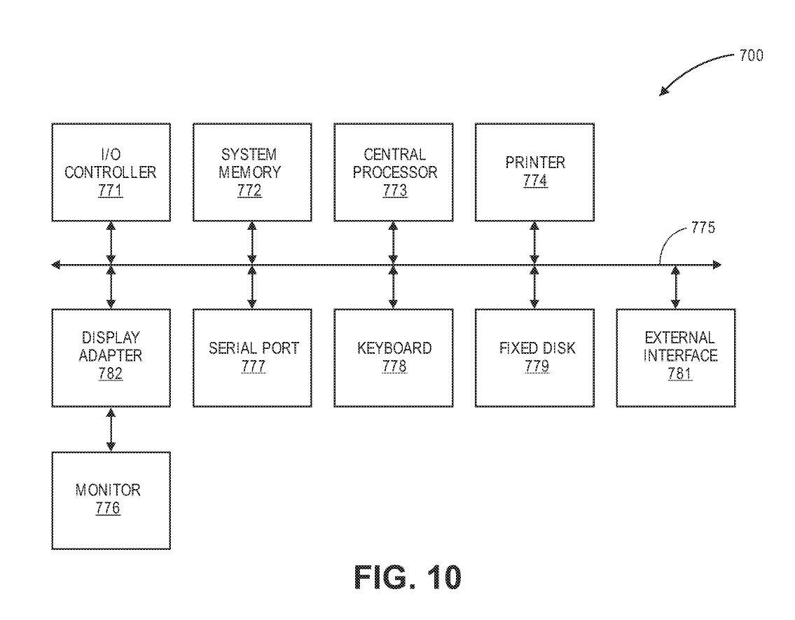

The various processes described herein with reference to FIGS. may be executed using one or more computer apparatuses, subsystems, or components to facilitate the functions described herein. Examples of such subsystems or components are shown in FIG. 10. The subsystems shown in FIG. 10 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771 (which can be a processor or other suitable controller), can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

Embodiments of the invention are not limited to the above-described embodiments. For example, although separate functional blocks are shown for an issuer, payment processing system, and acquirer, some entities perform all of these functions and may be included in embodiments of invention.

Specific details regarding some of the above-described aspects are provided above. The specific details of the specific aspects may be combined in any suitable manner without departing from the spirit and scope of embodiments of the invention. For example, portable consumer device authentication, consumer authentication, back end processing, data analysis, data collection, and other transactions may all be combined in some embodiments of the invention. However, other embodiments of the invention may be directed to specific embodiments relating to each individual aspects, or specific combinations these individual aspects.

It should be understood that the present invention as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
a) receiving a transaction case comprising transaction data associated with an account, wherein the transaction data includes a first transaction score;
b) determining, by a server computer, a transaction score delta using the first transaction score and a second transaction score;
c) determining if the transaction score delta meets a delta trigger;
d) determining an immediate transaction score;
e) determining if the immediate transaction score meets an immediate trigger;
f) determining if the transaction data in the transaction case meets one or more rule triggers; and
g) performing additional processing if steps c), e), and f) are met.

2. The method of claim 1, wherein performing the additional processing comprises performing a notification strategy, which notifies a user that a transaction case is likely fraudulent.

3. The method of claim 2, wherein performing the additional processing further comprises storing the transaction data in the transaction case in a database, and wherein the steps a), c), d), e), f), and g) are also performed by the server computer.

4. The method of claim 1, further comprising:
analyzing, by the server computer, the transaction data in the transaction case and stored additional transaction data in the database;
determining, by the server computer, a pattern associated with previous transaction cases;
determining, by the server computer, if the transaction data in the transaction case meets one or more strategy rule triggers, wherein the strategy rule trigger is associated with a strategy rule based on the pattern; and
performing the notification strategy if the strategy rule trigger is met, thereby determining whether the transaction case is likely to be fraudulent.

5. The method of claim 1, wherein the additional processing further comprises placing a block on the account if one or more of the delta trigger, the immediate trigger, the rule trigger, or the strategy rule trigger, are met.

6. The method of claim 3, wherein the notification strategy comprises:
contacting, in real-time, the user via at least one of the following: SMS, e-mail, phone call, and interactive voice response;
requesting further action from the user if the user is not immediately reached; and
recording and storing, in a database, whether the user has been contacted.

7. The method of claim 6, further comprising placing a block on the account if one or more of the delta trigger, the immediate trigger, or the rule trigger are met, and if the user is not immediately reached.

8. The method of claim 1, wherein the delta trigger is met when the transaction score delta associated with the transaction case exceeds a threshold transaction score delta.

9. The method of claim 1, wherein the immediate trigger is met when the immediate transaction score associated with the transaction case exceeds a threshold immediate transaction score.

10. The method of claim 1, wherein the one or more rule triggers are not based on the first transaction score.

11. A server computer, comprising a processor, and a non-transitory computer readable medium comprising code executable by the processor to perform the method, the method comprising:
a) receiving a transaction case comprising transaction data associated with an account, wherein the transaction data includes a first transaction score;
b) determining a transaction score delta using the first transaction score and a second transaction score;
c) determining if the transaction score delta meets a delta trigger;
d) determining an immediate transaction score;
e) determining if the immediate transaction score meets an immediate trigger;
f) determining if the transaction data in the transaction case meets one or more rule triggers; and
g) performing additional processing if steps c), e), and f) are met.

12. The server computer of claim 11, wherein performing the additional processing comprises performing a notification strategy to a user associated with the account if one or more of the delta trigger, the immediate trigger, or the rule trigger, are met, thereby determining whether the transaction case is likely to be fraudulent.

13. The server computer of claim 12, wherein performing the additional processing further comprises storing the transaction data in the transaction case in a database, and wherein the steps a), c), d), e), f), and g) are also performed by the server computer.

14. The server computer of claim 13, wherein the method further comprises:
analyzing, by the server computer, the transaction data in the transaction case and stored transaction data in the database;
determining, by the server computer, a pattern associated with previous transaction cases;
determining, by the server computer, if the transaction data in the transaction case meets one or more strategy rule triggers, wherein the strategy rule trigger is associated with a strategy rule based on the pattern; and
performing the notification strategy if the strategy rule trigger is met, thereby determining whether the transaction case is likely to be fraudulent.

15. The server computer of claim 11, wherein the additional processing further comprises placing a block on the account if one or more of the delta trigger, the immediate trigger, the rule trigger, or the strategy rule trigger, are met.

16. The server computer of claim 13, wherein the notification strategy comprises:
contacting, in real-time, the user via at least one of the following: SMS, e-mail, phone call, and interactive voice response;
requesting further action from the user if the user is not immediately reached; and
recording and storing, in the database, whether the user has been contacted.

17. The server computer of claim 16, wherein the method further comprises placing a block on the account if one or more of the delta trigger, the immediate trigger, or the rule trigger are met, and if the user is not immediately reached.

18. The server computer of claim 11, wherein the delta trigger is met when the transaction score delta associated with the transaction case exceeds a threshold transaction score delta.

19. The server computer of claim 11, wherein the immediate trigger is met when the immediate transaction score associated with the transaction case exceeds a threshold immediate transaction score.

20. The server computer of claim 11, wherein the one or more rule triggers are not based on the first transaction score.
